(19) United States
(12) Patent Application Publication
(10) Pub. No.: US 2022/0101371 A1
(43) Pub. Date: Mar. 31, 2022

(54) SYSTEM FOR ONLINE ADVERTISING ANALYTICS

(71) Applicant: Kaci Anne Beerbower, Austin, TX (US)

(72) Inventor: Kaci Anne Beerbower, Austin, TX (US)

(21) Appl. No.: 16/903,094

(22) Filed: Jun. 16, 2020

(51) Int. Cl. G06Q 30/02; G06N 20/00

(52) U.S. Cl. CPC G06Q 30/0244; G06N 20/00; G06Q 30/0247

(57) ABSTRACT

A digital marketing and analytics system is disclosed, comprising a server having a server engine operable to communicate with a predictive analytics module. The predictive analytics module analyzes a plurality of metrics and transmits the plurality of metrics to an aggregation module to aggregate the plurality of metrics from a plurality of advertisement services and determine an advertising-to-sales ratio for a business.

### CROSS-REFERENCE TO RELATED APPLICATIONS

The present application claims priority to U.S. Provisional Patent Application 62/943,061 filed on Dec. 3, 2019, entitled “SYSTEM FOR ONLINE ADVERTISING ANALYTICS” the entire disclosure of which is incorporated by reference herein.

### TECHNICAL FIELD

The embodiments generally relate to advertising and, more specifically, relate to analytics systems.

### BACKGROUND

Marketing has evolved from an exclusively creative process to a data-driven process. Businesses and marketing organizations use analytics to determine the outcomes of campaigns or efforts and to educate and guide investment decisions and consumer targeting. For example, marketing organizations use various demographic studies, customer segmentation, and other techniques to identify a suitable strategy for advertising.

Web analytics allow marketers to collect session-level information about interactions on a website or mobile application. It is common for businesses and marketing organizations to employ a multitude of advertisement systems across various platforms, which complicates the advertisement analytics processes. Due to the technical nature of advertisement analytics, it is not uncommon for marketing to consume the majority of a business's expenditures.

In the current arts, marketing campaigns are integrated across various application programming interfaces (API's) to ensure the campaign has the opportunity to reach the highest number of a high-value targeted audience. Many systems in the current arts do not include a predictive model to incorporate machine-learning to increase the return on advertisement spending.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments provided herein disclose a digital marketing and analytics system comprising a server having a server engine operable to communicate with a predictive analytics module. The predictive analytics module analyzes a plurality of metrics and transmits the plurality of metrics to an aggregation module to aggregate the plurality of metrics from a plurality of advertisement services and determine an advertising-to-sales ratio for a business.

The embodiments provide a system and method for analyzing online advertising platforms to determine which digital advertising campaigns earn the most money. The system facilitates the maximization of return on advertising investments using predictive analytics and machine-learning techniques described herein.

In one aspect, the system further comprises a dissociation module to dissociate the advertising-to-sales ratio to determine a most valuable advertisement service.

In one aspect, the plurality of metrics is comprised of at least one of the following: industry information, sub-industry information, business nature, goods and/or services sold, number of customers, target audience information, and campaign goals. Further, current systems require the manual management of various capabilities without a means for automatically updating advertisement protocols to increase the return on investment.

In one aspect, a machine learning engine is provided to receive the plurality of metrics and determine a suitable marketing campaign strategy.

In one aspect, the system includes a management engine to manage the campaign strategy and implement the campaign strategy on one or more marketing outlets.

In one aspect, the plurality of campaign metrics are provided on a campaign analytics interface provided on a display of a computing device.

In one aspect, a predictive analytics interface provides the user a means for inputting a plurality of metrics corresponding to a business, wherein the plurality of metrics are transmitted to the machine learning engine.

In one aspect, a campaign start/stop engine is in operable communication with the machine learning engine, wherein the start/stop engine is configured to start and stop the marketing campaign.

In one aspect, the marketing campaign is provided on a plurality of marketing outlets.

In one aspect, a predictive metrics engine is in operable communication with the predictive analytics interface to provide predictive analysis thereto.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of the server engine and modules, according to some embodiments;

FIG. 2 illustrates a block diagram of the metrics engine, according to some embodiments;

FIG. 3 illustrates a block diagram of the machine learning engine, according to some embodiments;

FIG. 4 illustrates a block diagram of the network infrastructure, according to some embodiments;

FIG. 5 illustrates a screenshot of the predictive analytics interface, according to some embodiments; and

FIG. 6 illustrates a screenshot of the campaign analytics interface, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments described herein provide a system and method for analyzing online advertising platforms to determine which digital advertising campaigns earn the most money. The system facilitates the maximization of return on advertising investments using predictive analytics and machine-learning techniques. The system permits cross-platform advertising metrics to be universally compatible and understandable to provide specific recommendations for future advertising campaigns to maximize the business's return on investment.

The embodiments reduce or eliminate a business's need to conduct expensive advertisement analytics across multiple platforms individually by using predictive analytics. The system can analyze advertisement campaign metrics for a plurality of advertisement services (e.g., social media services, search engines, etc.).

In some embodiments, the system monitors metrics which may include, but are not limited to, total clocks, total conversions, total impressions, total amount spent on a campaign or multiple campaigns, total conversion rate, a conversion rate compared with the total amount spent across platforms, total engagement rate across platforms, and total advertising-to-sales ratio across platforms. One skilled in the arts will readily understand that the system may be used to analyze various other marketing and sales metrics.

The system utilizes a machine learning engine to receive various marketing campaign analytics and determine a suitable marketing campaign strategy for each marketing platform utilized by the user and their associated organization. For example, the machine learning engine may determine favorable marketing campaign outlets and systems which produce the highest return on investment for their marketing campaign.

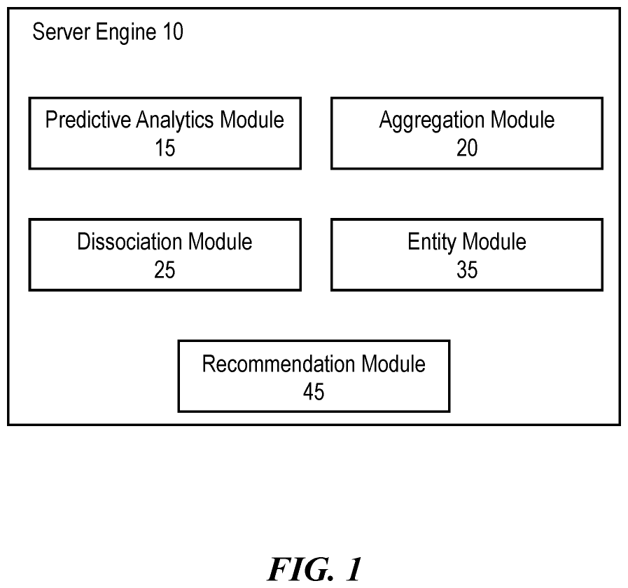

FIG. 1 illustrates a server engine 10 and modules thereof including a predictive analytics module 15 configured to determine which online advertising platform(s) will earn a business the highest return on advertisement investment. The predictive analytics module 15 may utilize various metrics such as industry information, sub-industry information, business nature, goods and/or services sold, number of customers, target audience information (location, demographic, etc.), and advertisement campaign goal. An aggregation module 20 aggregates the advertising-to-sales ratio or similar metric across a plurality of advertisement platforms such as social media platforms, search engines and other advertisement services to determine the overall performance of the advertisement campaign. A dissociation module 25 dissociates the advertising-to-sales ratio or similar metric across the plurality of advertisement platforms to determine each individual advertisement campaign's performance for each of the advertisement platforms to facilitate the determination of the most valuable advertisement campaigns. An entity module 35 is operable to analyze the user activities, preferences, and the like. This may include the users preferred social media and advertising systems. A recommendation module 45 is configured to communicate changes a user should make based on real-time metrics received by the system. The recommendation module 45 will utilize manually built algorithms and machine learning to generate recommendations for the user.

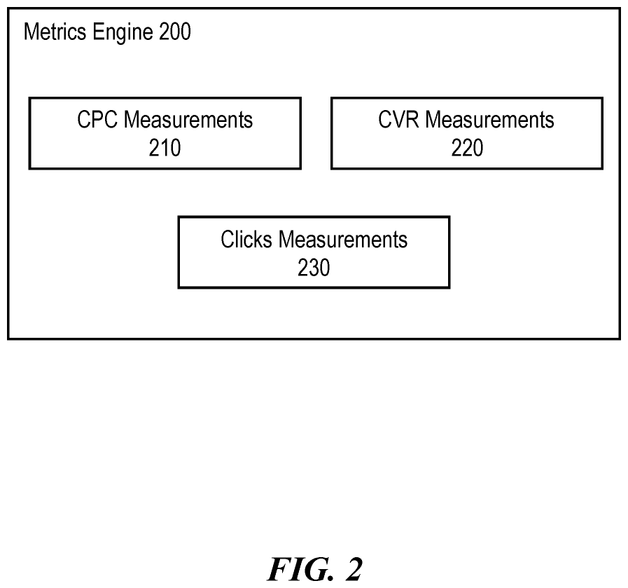

FIG. 2 illustrates a block diagram of the metrics engine 200 configured to provide data quality assurance measurements including cost per clock (CPC) measurements 210, conversion rate (CVR) measurements 220, and click measurements 230 (i.e., engagements). The CPC measurements 210 measure the total cost per the total number of clicks on an advertisement. The CVR measurements 220 measure the proportion of people which take a particular action on the advertisement. The action measured may be selected by the user and may include, for example, purchasing a product, engaging with content, or other like action. One skilled in the arts will readily understand that the CPC and CVR measurements may change across platforms. The clicks measurements 230 count the number of clicks on an advertisement. This may also count views of an advertisement.

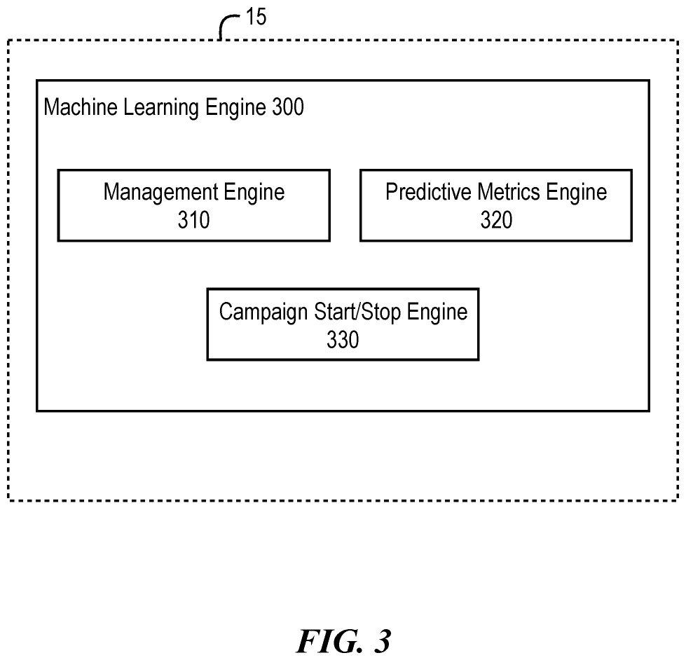

FIG. 3 illustrates a block diagram of the predicative analytics module 15 comprising a machine learning engine 300 configured to analyze, predict, and modify the return on advertising to increase the return on investment of the advertising campaign. The management engine 310 provides automated management functionalities and the ability to pause and enable campaigns in view of updated advertising budgets or measurements performed by the metrics engine 200 (see FIG. 2) in real-time. Predictive analytics operating in real-time allow the user to compare the return on investment by choosing multiple campaigns and checking each campaign accordingly. A predictive metrics engine 320 provides a means for predicting future metrics such as predicting the next month's or quarter's metrics based on real-time metrics and predictive analytics. The campaign start/stop engine 330 allows the system to autonomously start and stop a campaign depending on the metrics received by the machine learning engine 300. This allows the system to stop the campaign if the user is experiencing a loss in return on investment or if a loss is predicted based on real-time metrics. The predictive analytics module functions to produce the maximum revenue for the user.

In some embodiments, the user may function as an employee of an organization operating an organization account. The organization account will provide the ability to assign permissions to one or more users while maintaining users under a single account. An administrative account or administrative user may manage each user account within the organization account.

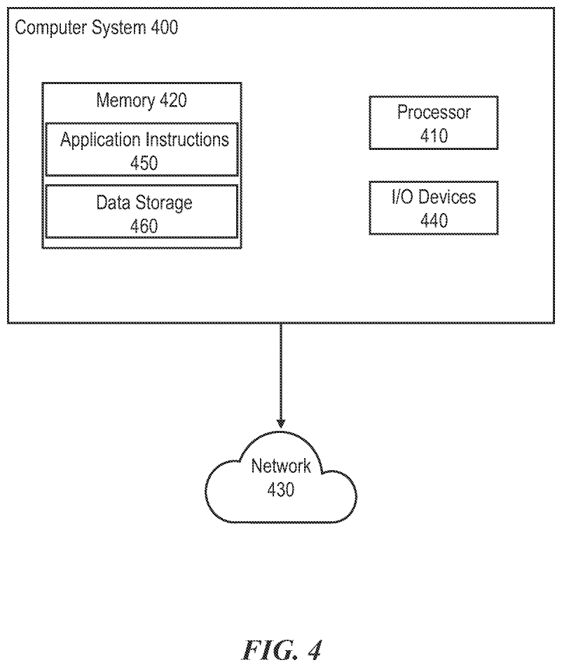

FIG. 4 illustrates a computer system 400, which may be utilized to execute the processes described herein. The computing system 400 is comprised of a standalone computer or mobile computing device, a mainframe computer system, a workstation, a network computer, a desktop computer, a laptop, or the like. The computer system 400 includes one or more processors 410 coupled to a memory 420 via an input/output (I/O) interface. Computer system 400 may further include a network interface to communicate with the network 430. One or more input/output (I/O) devices 440, such as video device(s) (e.g., a camera), audio device(s), and display(s) are in operable communication with the computer system 400. In some embodiments, similar I/O devices 440 may be separate from computer system 400 and may interact with one or more nodes of the computer system 400 through a wired or wireless connection, such as over a network interface.

Processors 410 suitable for the execution of a computer program include both general and special purpose microprocessors and any one or more processors of any digital computing device. The processor 410 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 400 and other devices attached to a network 430, such as other computer systems, or between nodes of the computer system 400. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 420 may include application instructions 450, configured to implement certain embodiments described herein, and a database 460, comprising various data accessible by the application instructions 450. In one embodiment, the application instructions 450 may include software elements corresponding to one or more of the various embodiments described herein. For example, application instructions 450 may be implemented in various embodiments using any desired programming language, scripting language, or combination of programming languages and/or scripting languages (e.g., C, C++, C#, JAVA®, JAVASCRIPT®, PERL®, etc.).

The steps and actions of the computer system 400 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 410 such that the processor 410 can read information from, and write information to, the storage medium. In the alternative, the storage medium may be integrated into the processor 410. Further, in some embodiments, the processor 410 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

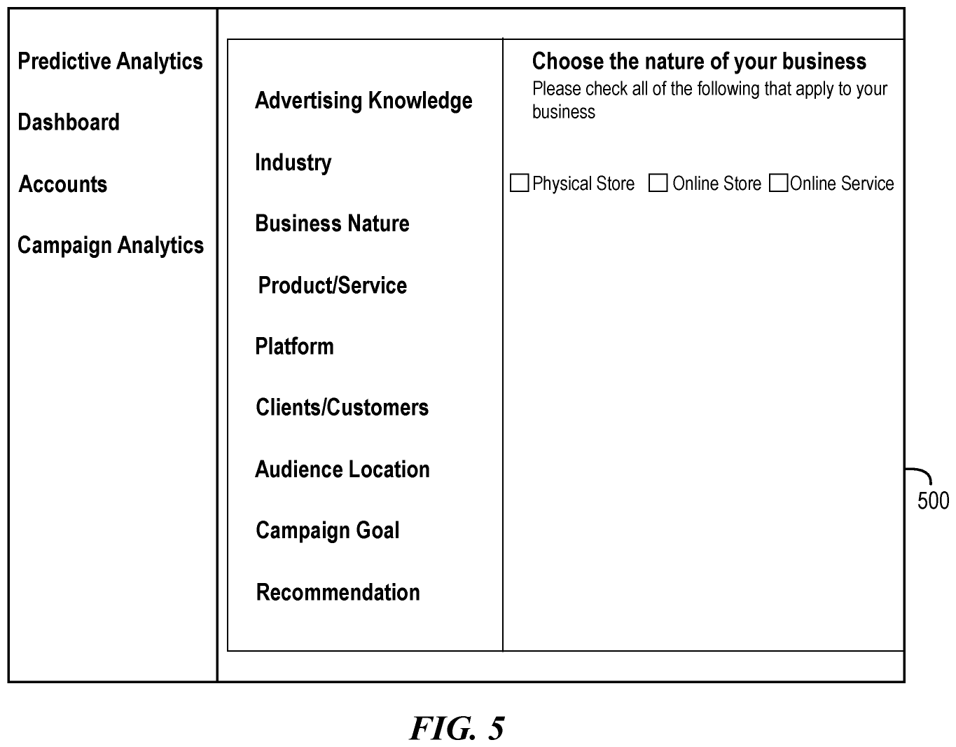

FIG. 5 illustrates a screenshot of the user interface 500 comprising a plurality of selectable tabs, including a predictive analytics tab to display a user interface having information received from the predictive analytics module. A dashboard tab displays user information provided on a user dashboard. An accounts tab permits the user to view various account information and the accounts of other users within an organization account. A campaign analytics tab provides advertisement campaign analytics to the user received from the analytics module. The user may select each tab to view the information provided therein. In one example, the predictive analytics tab provides a plurality of selectable tabs including an advertising knowledge tab, an industry tab, a business nature tab, a product/service tab, a platform tab, a clients/customers tab, an audience location tab, a campaign goal tab, and a recommendation tab. The user may select various parameters within each tab. In one example, the business nature tab allows the user to select a business type, such as a physical store, online store, or online service. The user input may be utilized by the machine learning engine to determine a suitable marketing campaign strategy.

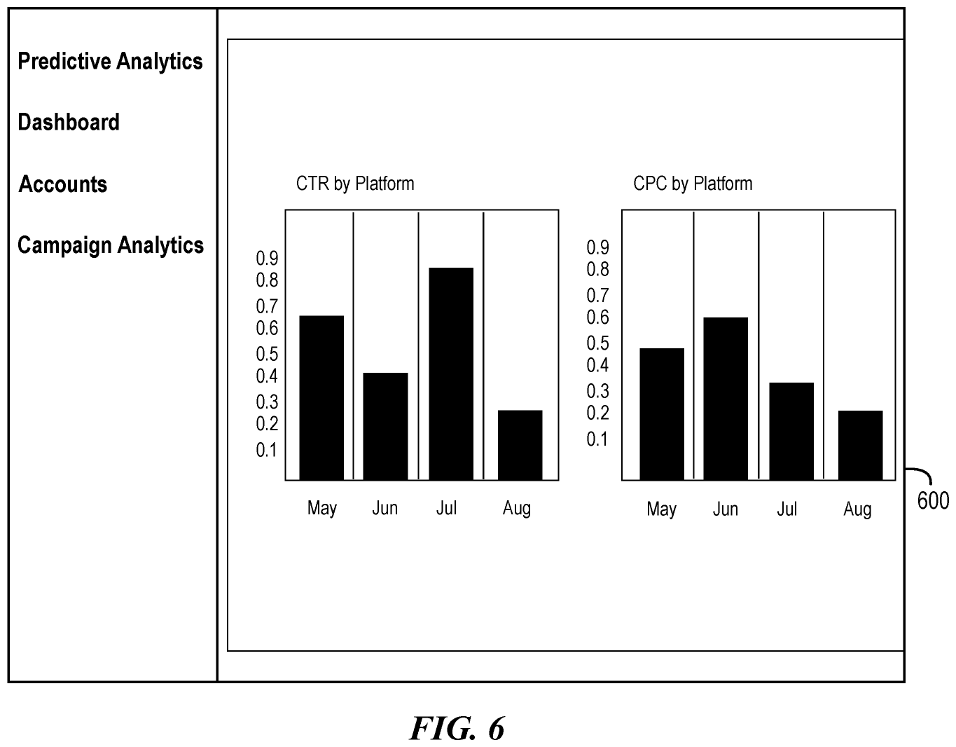

FIG. 6 illustrates a screenshot of the campaign analytics interface 600 configured to provide a plurality of analytics displays various metrics such as, for example, a click-through rate, cost-per-click, conversion rate, and amount spent per platform. One skilled in the arts will readily understand that various metrics may be displayed according to the users preferred analytical measurements. The campaign analytics interface may be utilized to provide the user with a visual representation of the success or failure of various marketing campaigns for each marketing platform utilized.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for anyone of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A digital marketing and analytics system, comprising:
a server comprising a server engine operable to communicate with a predictive analytics module to analyze a plurality of metrics and transmit the plurality of metrics to an aggregation module to aggregate the plurality of metrics from a plurality of advertisement services to determine an advertising-to-sales ratio for a business.

2. The system of claim 1, further comprising a dissociation module to dissociate the advertising-to-sales ratio to determine a most valuable advertisement service.

3. The system of claim 2, further comprising a machine learning engine to receive a plurality of campaign metrics and determine a suitable marketing campaign strategy.

4. The system of claim 3, wherein the plurality of campaign metrics are provided on a campaign analytics interface provided on a display of a computing device.

5. The system of claim 4, further comprising a predictive analytics interface to provide the user a means for inputting a plurality of metrics corresponding to a business, wherein the plurality of metrics are transmitted to the machine learning engine.

6. The system of claim 5, a campaign start/stop engine in operable communication with the machine learning engine, wherein the start/stop engine is configured to start and stop the marketing campaign.

7. The system of claim 6, wherein the marketing campaign is provided on a plurality of marketing outlets.

8. The system of claim 7, further comprising a predictive metrics engine in operable communication with the predictive analytics interface to provide predictive analysis thereto.

9. The system of claim 1, wherein the plurality of metrics is comprised of at least one of the following: industry information, sub-industry information, business nature, goods and/or services sold, number of customers, target audience information, and campaign goals.

10. A digital marketing and analytics system, comprising:
a server comprising a server engine operable to communicate with a predictive analytics module to analyze a plurality of metrics and transmit the plurality of metrics to an aggregation module to aggregate the plurality of metrics from a plurality of advertisement services to determine an advertising-to-sales ratio for a business;
a machine learning engine to receive the plurality of metrics and determine a suitable marketing campaign strategy; and
a management engine to manage the campaign strategy and implement the campaign strategy on one or more marketing outlets.

11. The system of claim 10, further comprising a dissociation module to dissociate the advertising-to-sales ratio to determine a most valuable advertisement service.

12. The system of claim 11, wherein the plurality of campaign metrics are provided on a campaign analytics interface provided on a display of a computing device.

13. The system of claim 12, further comprising a predictive analytics interface to provide the user a means for inputting a plurality of metrics corresponding to a business, wherein the plurality of metrics are transmitted to the machine learning engine.

14. The system of claim 13, a campaign start/stop engine in operable communication with the machine learning engine, wherein the start/stop engine is configured to start and stop the marketing campaign.

15. The system of claim 15, wherein the marketing campaign is provided on a plurality of marketing outlets.

16. The system of claim 16, further comprising a predictive metrics engine in operable communication with the predictive analytics interface to provide predictive analysis thereto.

17. The system of claim 16, wherein the plurality of metrics is comprised of at least one of the following: industry information, sub-industry information, business nature, goods and/or services sold, number of customers, target audience information, and campaign goals.

18. A method for digital marketing and analytics, the method comprising the steps of:
analyzing, via a predictive analytics module, a plurality of metrics, and transmitting the plurality of metrics to an aggregation module;
aggregating, via the aggregation module, the plurality of metrics from a plurality of advertisement services to determine an advertising-to-sales ratio for a business; and
dissociating, via a dissociation module, the advertising-to-sales ratio to determine a most valuable advertisement service.

19. The method of claim 18, wherein the plurality of metrics is comprised of at least one of the following: industry information, sub-industry information, business nature, goods and/or services sold, number of customers, target audience information, and campaign goals.

20. The method of claim 19, further comprising receiving, via a machine learning engine, a plurality of campaign metrics, and determining a suitable marketing campaign strategy.
